(19) United States
(12) Patent Application Publication
(10) Pub. No.: US 2007/0243472 A1
(43) Pub. Date: Oct. 18, 2007

(54) Holographic recording medium, recording method thereof, reading method thereof, recording apparatus and reading apparatus for holograohic recording medium

(75) Inventors: Toshio Ando, Kanagawa-ken (JP); Akihiko Nomura, Kanagawa-ken (JP)

Correspondence Address: THE NATH LAW GROUP, 112 South West Street, Alexandria, VA, 22314, US

(73) Assignee: VICTOR COMPANY OF JAPAN, LIMITED, Yokohama-shi (JP)

(21) Appl. No.: 11/785,299

(22) Filed: Apr. 17, 2007

(30) Foreign Application Priority Data
Apr. 18, 2006 (JP) P2006-114460
Oct. 13, 2006 (JP) P2006-279812
Feb. 20, 2007 (JP) P2007-039046

(51) Int. Cl. G03H 1/04

(52) U.S. Cl. 430/1; 430/2; 359/35; 359/3

(57) ABSTRACT

A holographic recording medium 1 includes a holographic recording layer 7 having information recorded by use of recording beams L1, L2 and a two-state variable layer 5 arranged on one side of the holographic recording medium 1 where the recording beams L, L2 radiate from the holographic recording layer 7. In the holographic recording medium 1, the two-state variable layer 5 is made from a material whose state can be changed from a first state to a second state by receiving a light and whose reflectivity can be changed from a first reflectivity corresponding to the first state to a second reflectivity corresponding to the second state. The second reflectivity is higher than the first reflectivity.

### BACKGROUND OF THE INVENTION

1. Field of the Invention

The present invention relates to a holographic recording medium for recording information through the use of holography, a recording method of recording the information into the holographic recording medium, a reading method of reading the information from the holographic recording medium, a recording apparatus for recording the information into the holographic recording medium, and a reading apparatus for reading the information from the holographic recording medium.

2. Description of Related Art

The recording of information into a holographic recording medium is accomplished by irradiating a recording signal beam based on image information and a recording reference beam to a recording layer of the medium thereby forming interference fringes in the recording layer. While, the reading of information from the holographic recording medium is accomplished by irradiating a reading reference beam to the recording layer containing recorded image information and continuously reading out the image information.

The holographic recording technology has been expected as a high-speed and high-capacity optical recording system to replace a conventional bit-by-bit recording system used in CD, DVD, Blu-lay disc, etc.

The holographic recording medium is roughly classified to either a transmissive medium (no reflecting layer) where recording/reading is accomplished by transmitted lights or a reflective medium where recording/reading is accomplished by use of reflecting lights from a reflecting layer.

For the transmissive medium, there exist one method where information is recorded by irradiating a recording signal beam and a recording reference beam from an identical side against a recording medium's surface and the information is read out by irradiating a reading reference beam to a recording position thereby allowing a transmission of a diffraction light of hologram (so-called “transmissive hologram” on classification), and another method where information is recorded by irradiating a recording signal beam and a recording reference beam from different sides against a recording medium's surface and the information is read out by irradiating a reading reference beam to a recording position thereby allowing a reflection of a diffraction light of hologram (so-called “reflective hologram” on classification).

In the transmissive hologram, a method of irradiating a reading reference beam from an opposite surface to a surface to which the recording signal beam and the recording reference beam are irradiated at recording thereby emitting the reading beam as a phase conjugate beam, will be referred to as “phase conjugate reading”. This phase conjugate reading is regarded as an effective reading method allowing image information to be reproduced with high SNR (Signal to Noise Ratio) and low distortion since substantial distortion in an optical system (e.g. aberrations in lens system) can be cancelled at reading.

In the transmissive medium (incl. transmissive hologram, reflective hologram), however, a recording/reading apparatus is apt to be large-sized since optical recording/reading systems are required on both sides of a recording surface of the medium.

On the other hand, in the reflective medium, it is possible to miniaturize a recording/reading apparatus since there is only required an optical recording/reading system on one side of the recording surface of the medium. Accordingly, in the application of holographic recording to an optical disc, it is advantageous to adopt a reflective medium. Furthermore, it is necessary to provide tracking/focusing servo systems in the application of holographic recording to an optical disc. Thus, the reflective medium is advantageous in view of detecting servo beams used for the tracking/focusing servo systems.

In the reflective medium, however, there is a possibility that when recording or reading information, optical noise is produced under the influence of reflecting beams, producing a problem to be solved in the reflective medium.

Japanese Patent Laid-Open Publication No. 2004-185707 discloses a holographic recording medium provided to solve the above-mentioned problem.

This holographic recording medium has a transparent substrate in the form of a disc. On the transparent substrate, there are laminated a polarization variable layer, a holographic recording layer, a reflecting film (reflecting layer) and another substrate as a protective layer, in sequence.

In operation, when recording information in this holographic recording medium, the polarization variable layer operates to differentiate an incident beam from a reflected beam by 90 degrees in terms of polarization and direction of vibration. Accordingly, there is no possibility that the incident light interferes with the reflected beam, allowing unnecessary interference fringes to be reduced. In addition, as an unnecessary grating is reduced in the holographic recording medium, it is also possible to prevent its SNR at playing from deteriorating. Similar holographic recording mediums are disclosed in Japanese Patent Laid-Open Publication No. 2005-215456 and “Consumer Holographic ROM Reader with Mastering and Replication Technology”, Ernest Chuang et al., IEEE, p. 224-226 (2006), too.

### SUMMARY OF THE INVENTION

It should be noted that even when recording the information in the holographic recording medium disclosed in Japanese Patent Laid-Open Publication No. 2004-185707, a recording signal beam and a recording reference beam are reflected by the reflecting layer, so that respective reflected beams pass through the holographic recording layer.

Thus, the holographic recording layer is exposed by not only the recording signal beam and the recording reference beam both entering from the side of the transparent substrate but also the recording signal beam and the recording reference beam reflected by the reflecting layer and subsequently entering the holographic recording layer. As a result, the holographic recording medium is subjected to unnecessary exposure, causing the multiplexing number allowing a multiplexing (so-called dynamic range) to be reduced.

In addition, as respective reflecting beams of the recording signal beam and the recording reference beam are characterized by identical polarizations, in other words, identical directions of vibration, unnecessary interference fringes are produced in the holographic recording layer disadvantageously. Consequently, there is produced an unnecessary grating that is at the root of noises in reading information recorded in the holographic recording medium, thereby deteriorating a SNR of the information.

Under the above-mentioned problems, an object of the present invention is to provide a holographic recording medium which can increase the multiplexing number allowing a multiplexing and also improve a SNR in reading information recorded in the medium. In connection with the provision of the holographic recording medium, another object of the present invention is to provide a recording method for the above holographic recording medium, a reading method of the medium, a recording apparatus for the medium and a reading apparatus for the medium.

In order to achieve the above object, according to a first aspect of the present invention, there is provided a holographic recording medium comprising: a holographic recording layer for recording information holographically by incident recording beams; and a two-state variable layer arranged on one side of the holographic recording layer in a thickness direction thereof, the one side of the holographic recording layer being opposite to an incident side of the holographic recording layer; wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity.

According to a second aspect of the invention, the holographic recording medium of the first aspect further comprises a dielectric layer arranged between the holographic recording layer and the two-state variable layer.

According to a third aspect of the invention, the holographic recording medium of the second aspect further comprises a substrate in which format signals for controlling a recording of the information into the holographic recording medium or a readout of the information from the holographic recording medium are recorded, wherein the substrate is arranged on one side of the two-state variable layer in a thickness direction thereof, the one side of the two-state variable layer being opposite to the incident side of the holographic recording layer.

In the holographic recording medium of any one of the first aspect to the third aspect, according to a fourth aspect of the invention, the two-state variable layer is made from any one of a phase change material, an inorganic material and an organic dye material.

According to a fifth aspect of the invention, there is also provided a recording method of recording information into a holographic recording medium, wherein: the holographic recording medium comprises: a holographic recording layer for recording the information holographically by incident recording lights; and a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and the recording method comprises: a reflectivity setting step of setting that the two-state variable layer has the first reflectivity corresponding to the first state; and a recording step of recording the information into the holographic recording layer by the incident recording beam.

In the recording method of the fifth aspect, according to a sixth aspect of the invention, the incident recording beams used at the recording step comprise a first beam containing the information and a second beam for recording the information into the holographic recording layer together with the first beam.

In the recording method of the sixth aspect, according to a seventh aspect of the invention, the recording step comprises: a step of allowing the first beam to enter the holographic recording medium at a first angle with a normal line perpendicular to an incident plane of the holographic recording medium for the incident recording beam; and a step of allowing the second beam to enter the holographic recording medium at a second angle with respect to the normal line.

In the recording method of the seventh aspect, according to an eighth aspect of the invention, the first angle is equal to 0 degree.

In the recording method of any one of the fifth aspect to the eighth aspect, according to a ninth aspect of the invention, a setting beam for setting the reflectivity of the two-state variable layer to the first reflectivity correspond to the first state is used at the reflectivity setting step.

According to a tenth aspect of the invention, there is further provided a reading method of reading information from a holographic recording medium, wherein: the holographic recording medium comprises: a holographic recording layer for recording the information horographically by incident recording beams; and a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and the reading method comprises: a reflectivity setting step of setting the reflectivity of the two-state variable layer to the second reflectivity corresponding to the second state; and a reading step of reading the information from the holographic recording layer by a reading beam.

In the reading method of the tenth aspect, according to an eleventh aspect of the invention, a setting beam for changing the reflectivity of the two-state variable layer from the first reflectivity corresponding to the first state to the second reflectivity corresponding to the second state is used at the reflectivity setting step.

In the reading method of the tenth aspect, according to a twelfth aspect of the invention, either a first beam having the information or a second beam for recording the information into the holographic recording layer together with the first beam is used at the reflectivity setting step.

According to a thirteenth aspect of the invention, there is still further provided a recording apparatus for recording information in a holographic recording medium wherein: the holographic recording medium comprises: a holographic recording layer for recording the information holographically by incident recording beams; and a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and the recording apparatus comprising: a first beam generator for generating a first beam having the information, the first beam constituting a part of the recording beam; a second beam generator for generating a second beam for recording the information in the holographic recording layer together with the first beam, the second beam constituting another part of the recording beam; and a third beam generator for generating a third beam for setting the reflectivity of the two-state variable layer to the first reflectivity corresponding to the first state.

According to a fourteenth aspect of the invention, there is still further provided a reading apparatus for reading information from a holographic recording medium wherein: the holographic recording medium comprises: a holographic recording layer for recording the information holographically by incident recording beams; and a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and the reading apparatus comprises: a first beam generator for generating a setting beam for setting the reflectivity of the two-state variable layer to the second reflectivity corresponding to the second state; and a second beam generator for generating a reading beam for reading the information recorded in the holographic recording layer.

### BRIEF DESCRIPTION OF THE DRAWINGS

FIG. 1 is a sectional view showing a lamination of a holographic recording medium in accordance with a first embodiment of the present invention;

FIG. 2 is a view typically showing a recording method for the holographic recording medium;

FIG. 3 is a view typically showing a reading method for the holographic recording medium;

FIG. 4 is a view typically showing another reading method for the holographic recording medium;

FIG. 5 is a view showing a wavelength dependency on reflectivity and modulation rate on a two-state variable layer;

FIG. 6 is a view showing a relationship between normalized readout beam power and recording multiplicity;

FIG. 7 is a view showing a relationship between CNR and cumulated exposure energy;

FIGS. 8A and 8B are views showing images obtained by reading the holographic recording medium;

FIG. 9 is a sectional view showing a lamination of a holographic recording medium in accordance with a second embodiment of the present invention; and

FIG. 10 is a view typically showing a setting process for the two-state variable layer.

### DETAILED DESCRIPTION OF THE PREFERRED EMBODIMENTS

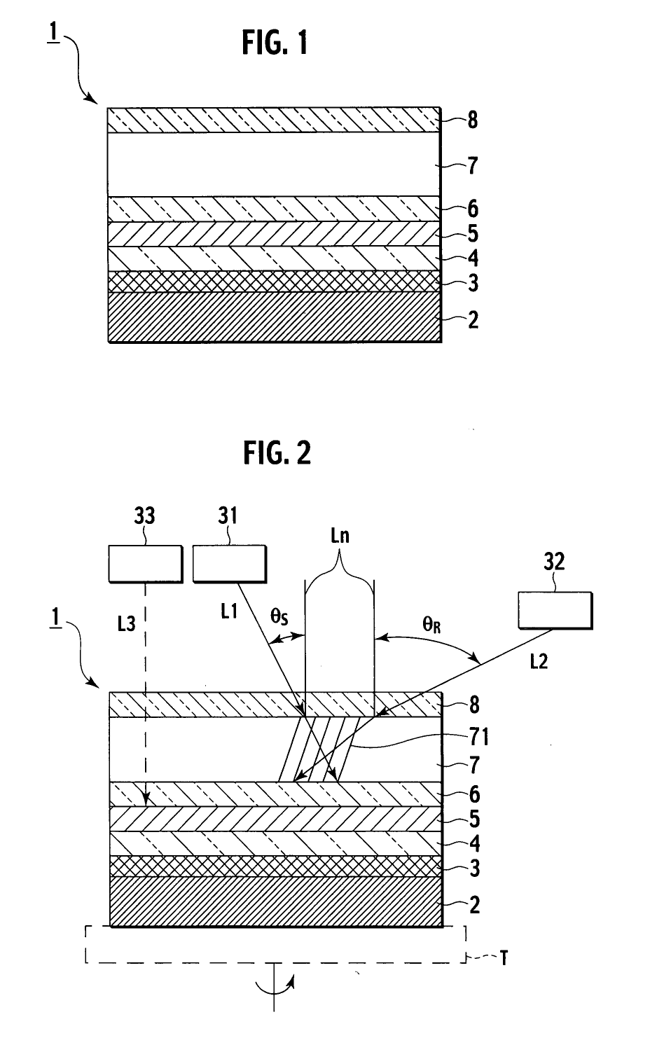

FIG. 1 is a sectional view showing a lamination of a holographic recording medium in accordance with a first embodiment of the present invention. The holographic recording medium 1 comprises a substrate 2, a reflecting layer 3 on the substrate 2, a first dielectric layer 4, a two-state variable layer 5, a second dielectric layer 6, a holographic recording layer 7 and a transparent substrate 8, in successive lamination. In arrangement, as shown in FIG. 1, the two-state variable layer 5 is position on one side of the holographic recording layer 7 in its thickness direction. This side of the holographic recording layer 7 is opposite to the other side where the transparent substrate 8 is positioned. Note that the other side may be referred to as “incident side” of the holographic recording layer 7.

Various beams, namely, recording signal beam (incident recording beam) L1, recording reference beam L2, reading reference beam L3, etc. (all described later, in detail) are irradiate from the incident side (i.e. upper side in the figure) toward the transparent substrate 8 and successively enter the interior of the holographic recording medium 1 through the transparent substrate 8.

The substrate 2 is made of glass, plastic material, such as polycarbonate, or metallic material, such as Ni-alloy, Ag-alloy and Al-alloy. The substrate 2 may be provided in the form of a card or a disc. In case of a disc-shaped substrate 2, it is desirable that format signals for controlling a recording of the information into the holographic recording medium 1 or a readout of the information from the holographic recording medium 1 are recorded in the form of concavities and convexities (irregularities). In arrangement, the substrate 2 is positioned on one side of the two-state variable layer 5 in the thickness direction. This side of the two-state variable layer 5 is opposite to the incident side of the holographic recording layer 7.

The reflecting layer 3 is formed by appropriate material, for example, Al, Ag, Al or Ag based alloy film, dielectric mirror having dielectrics laminated in multilayer, etc.

As materials for the first dielectric layer 4 and the second dielectric layer 6, there are preferably recommended inorganic transparent materials, for instance, Zn—S, Si—N, Si—O, Al—O, In—O, Zn—O, Sn—O, Ga—N, B—N, Al—N and their mixtures (e.g. ZnS−SiO₂, In₂O₃—SnO₂, In₂O₃—ZnO). Alternatively, organic transparent resin (e.g. polyolefin plastic, petroleum resin) is available for the first dielectric layer 4 and the second dielectric layer 6.

The number of dielectric layers is appropriately established from the viewpoint of improving optical characteristics, read-write characteristics, environment-resistance capability and so on. Corresponding to desired characteristics, different materials may be selected from the above-mentioned group of materials, forming respective layers in combination.

The two-state variable layer 5 is made from a special material. This material can play either a first state with a lower reflectively (e.g. a first reflectivity) or a second state with a higher reflectivity (e.g. second reflectivity) state in response to a light having a predetermined wavelength. By accepting a light, the same material can change its condition from the first state to the second state, reversibly or irreversibly. In other words, the two-state variable layer 5 may be either a reflectivity-variable layer changeable between the first state and the second state reversibly or another reflectivity-variable layer changeable from the first state with the first reflectivity to the second state with the second reflectivity irreversibly.

For the two-state variable layer 5, the above material is selected from various materials: phase change material; inorganic material; and organic dye material. In common with these materials, each reflectivity can be altered dependently of changes in terms of amount of irradiated beam and temperature. From these materials, it is desirable to select an appropriate material whose reflective property is characterized by a lower reflectivity of 4˜5% and a higher reflectivity exceeding at least 10% in response to incident beams. It should be noted that the reflectivity of the phase change material is changeable reversibly by heat, while the reflectivity of the inorganic material and that of the organic dye are together changeable irreversibly by heat.

When adopting the phase change material for the two-state variable layer 5, it is preferable that the same material has two conditions of an amorphous state and a crystallized state and that its reflectivity in the crystallized state is higher than that in the amorphous state.

Recommended for the phase change material are chalcogen-compounds (e.g. Sb—Te, Ge—Sb—Te, Ag—In—Sb—Te, etc.), which contains Se, Te, or the like, materials each having any of the above chalcogen-containing compounds as a base material and other additive elements, Te-containing oxide (e.g. Te—O—Pd) and so on.

Further, depending on its composition, the phase change material can be classified to an eutectic type material or a compound type material in terms of its structure in the crystallized state. Either eutectic type material or compound type material is available for the two-state variable layer 5.

When adopting an inorganic material having its reflectivity changeable irreversibly for the two-state variable layer 5, there are available oxide (e.g. Ag—O), Si—Cu alloy, Ge—Bi—N alloy and so on.

In adopting the oxide, such as Ag—O, the two-state variable layer 5 can be provided with a high reflectivity since it is physically deformed by irradiation of light. In adopting Si—Cu alloy, the layer 5 can be brought into a state of low reflectivity with a layer's structure where a Si-layer is laminated on a Cu-alloy layer. While, the layer 5 can be provided with a high reflectivity since the Si-layer and the Cu-alloy layer are alloyed to Si—Cu alloy by irradiation of light. In adopting Ge—Bi—N alloy, the layer 5 can be brought into a state of low reflectivity with a layer's structure having Bi—N and Ge—N in their mixed state. While, the layer 5 can be provided with a high reflectivity when N (nitrogen) is dissolved by irradiation of light, so that fine pores of nitrogen gas are dispersed.

When adopting an organic dye material having its reflectivity changeable irreversibly for the two-state variable layer 5, there are available cyanine dye, phthalocyanine dye, azo dye, etc. each of which has a reflectivity changed by irradiation of light.

In case of the two-state variable layer 5 made from the phase change material, preferably, respective materials and film thicknesses of the first dielectric layer 4, the two-state variable layer 5 and the second dielectric layer 6 are determined so that a difference in reflectivity between the amorphous state of the phase change material and the crystallized state of the same material gets larger. In other words, their materials and film thickness are selected in a manner that a difference between a layer's reflectivity in the amorphous state and another layer's reflectivity in the crystallized state increases due to an interaction of different refractive indexes “n” and different extinction coefficients “k” of the two-state variable layer 5 (in the amorphous state and the crystallized state) with respective refractive indexes “n” and respective extinction coefficients “k” of materials for the dielectric layers 4, 6.

If the two-state variable layer 5 is made from the organic dye material, the structure of the medium 1 may be modified so as to eliminate the first dielectric layer 4. In such a case, respective materials and film thicknesses of the two-state variable layer 5 and the second dielectric layer 6 have only to be determined so that a difference in reflectivity between a high-reflective state of the two-state variable layer 5 and a low-reflective state of the layer 5 grows larger.

The holographic recording layer 7 is produced by use of a material whose optical constants (e.g. refractive index, reflectivity, absorptivity) are modulated in between a layer's part where a recording signal beam and a recording reference beam (both described later) weaken each other and another layer's part where the recording signal beam and the recording reference beam intensify each other. For the holographic recording layer 7, there are available a variety of materials, for instance, photopolymer, chalcogenide compound, dye, dye-additive thermoplastic, photorefractive crystal and so on.

Note that the holographic recording layer 7 is classified broadly into either “rewritable” type layer or so-called “write-once” type layer allowing of writing once.

In adopting the rewritable holographic recording layer 7, it is desirable that a reflectivity variable layer whose reflectivity is changeable between a high value and a low value reversibly is employed for the two-state variable layer 5 in view of realizing a rewritable holographic recording medium.

On the other hand, in adopting the write-one holographic recording layer 7, either a reflectivity variable layer whose reflectivity is changeable between a high value and a low value reversibly or another reflectivity variable layer whose reflectivity is changeable from a low value to a high value irreversibly is usable for two-state variable layer 5.

Provided that the holographic recording layer 7 is formed with a thickness and a strength enough to double as the function of a substrate, for example, any of photopolymer, dye-additive thermoplastic and photorefractive crystal, the holographic recording medium 1 may be modified so as to eliminate the above substrate 2. Then, the above-mentioned layers (i.e. the dielectric layers, the two-state variable layer 5, the reflecting layer, etc.) have only to be appropriately laminated on the holographic recording layer 7 depending on required specifications.

We now describe a method of recording information into the holographic recording medium 1 constructed above.

FIG. 2 is a view showing the recording method to the holographic recording medium 1 typically. As shown in FIG. 2, a recording signal beam (i.e. a first beam of incident recording beams) L1 where the information is modulated by modulation signals is irradiated to the holographic recording medium 1 (from the side of the transparent substrate 8) at a first incident angle θ_{S}. Simultaneously, a recording reference beam (i.e. a second beam of the incident recording beams) L2 for recording information into the holographic recording layer 7 together with the recording signal beam L1 is irradiated at a second incident angle θ_{R}. Note that the incident angles θ_{S} and θ_{R} designate inclination angles of gradient from a normal line Ln of an optical incident plane in the holographic recording medium 1. These angles θ_{S} and θ_{R} may be equal to or different from each other. The recording signal beam L1 and the recording reference beam L2 constitute recording beams which form interference fringes 71 mentioned later to record the information into the holographic recording layer 7. The recording signal beam L1 is generated by a beam generator 31 (forming a first beam generator at recording), while the recording reference beam L2 is generated by a beam generator 32 (forming a second beam generator at recording).

The interference fringes 71 are produced in the holographic recording layer 7 since the recording signal beam L1 and the recording reference beam L2 irradiated above interfere with each other in the same layer 7, so that the information is recorded in the holographic recording medium 1. In this embodiment, a laser beam having a wavelength of 405 nm, 514.5 nm or 532 nm is used for the recording signal beam L1 and the recording reference beam L2.

When recording the information in the holographic recording layer 7, the two-state variable layer 5 is established to have a low reflectivity for the recording signal beam L1 and the recording reference beam L2. This establishment of the low reflectivity may be accomplished at that stage of shipment of the holographic recording medium 1 or accomplished before recording the information.

The establishment of the low reflectivity comes from a purpose of preventing the recording signal beam L1 and the recording reference beam L2 reflected on the two-state variable layer 5 from entering into the holographic recording layer 7 again and subsequently forming unnecessary interference fringes 71 in the layer 7 and another purpose of lowering unnecessary exposure of the holographic recording layer 7 due to reflected beams. With the establishment, it is possible to prevent a reduction of the number of possibilities of repeatedly recording (multiplexing) various information in an identical place in the holographic recording layer 7 (recording multiplicity).

Now, we describe a reflectivity setting process (i.e. reflectivity setting step) of changing (transition of) the two-state variable layer 5 from the first state of a low reflectivity (i.e. the first reflectivity) for the recording signal beam L1 and the recording reference beam L2 to the second state of a high reflectivity (i.e. the second reflectivity) for a later-mentioned reading reference beam (or reading beam) L4. In reading the information from the holographic recording layer 7, the readout operation could be realized effectively if the reflectivity of the two-state variable layer 5 has been established highly (i.e. the second reflectivity) for the reading reference beam LA. If adopting a phase change material for the two-state variable layer 5, its amorphous state corresponds to the first state with the first reflectivity (low reflectivity), while a crystallized state of the phase change material corresponds to the second state with the second reflectivity (high reflectivity).

In order to change the reflectivity of the two-state variable layer 5 from a lower value (e.g. the first reflectivity) to a higher value (the second reflectivity), a laser beam (i.e. setting beam or third beam) L3 suitable to the material of the two-state variable layer 5 is irradiated from the side of the transparent substrate 8 to a desired area in the layer 5 after completing to record the information in the holographic recording layer 7. The setting beam 13 is generated by the beam generator 33 (forming a first beam generator at reading). In common with the above-mentioned materials for the two-state variable layer 5, each reflectivity changes since the layer 5 is heated to produce an increase in temperature. In case of adopting the phase change material for the two-state variable layer 5, the reflectivity is changed by irradiating the setting beam L3 to the layer 5 so that its temperature becomes more than a crystallization temperature and subsequently cooling down the layer 5. Even when changing the reflectivity of the two-state variable layer 5 from a high one to a low one, the reflectivity may be altered by use of the setting beam (i.e. the third beam) 13 generated the beam generator 33 (forming a first beam generator at reading).

The irradiation of the setting beam L3 may be carried out by combining the following conditions in accordance with an adopted material appropriately:

(1) Wavelength: 300 nm ˜1500 nm, Beam power: 200 mW˜2000 mW

(2) Spot-diameter of laser beam L3: 0.3 μm˜100 μm

(3) Relative speed (scanning rate) against the holographic recording medium 1: 3 m/sec˜50 m/sec

(4) Track feeding pitch: 3 μm˜50 μm

If provided a holographic recording medium 1 in the form of a disc, it is mounted on a mount T and successively, a setting beam 13 is irradiated while rotating the medium 1 so as to satisfy the above condition (3), as shown in FIG. 2.

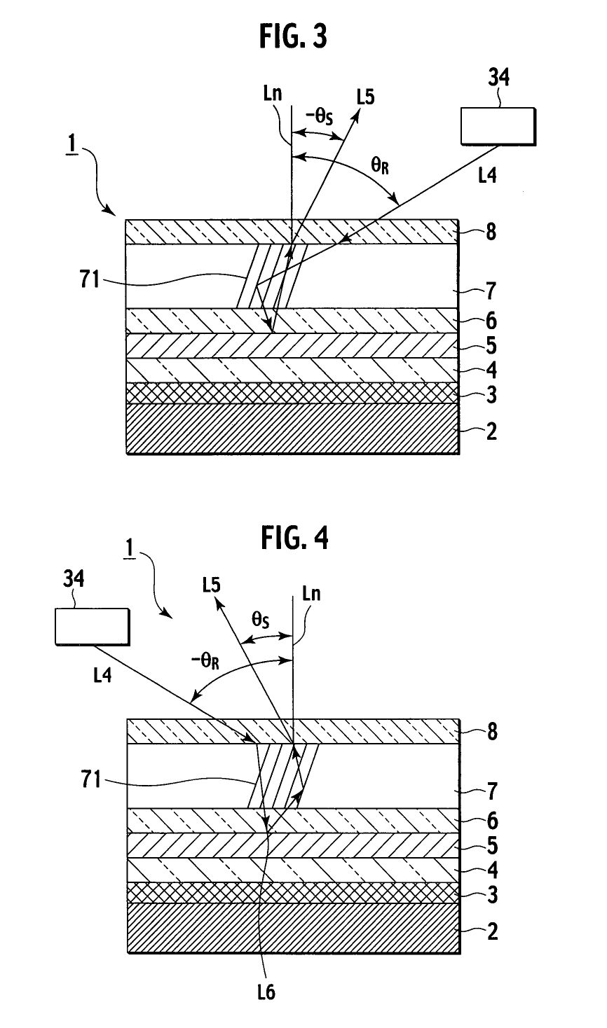

Next, we describe a reading method of reading the information from the holographic recording medium 1. FIG. 3 shows the reading method of the holographic recording medium 1 schematically. When reading the information from the holographic recording layer 7, it is established that the two-state variable layer 5 has a high reflectivity medium against the reading reference beam L4 emitted from the beam generator 34 (forming a second beam generator at reading), as stated before.

As shown in FIG. 3, the reading reference beam L4 for reading the information from the interference fringes 71 is irradiated to the holographic recording medium 1, from its one side facing transparent substrate 8, at an incident angle θ_{R} with the normal line Ln. Here, it should be noted that the incident angle θ_{R} of the reading reference beam L4 is equal to the incident angle θ_{R} of the recording reference beam L2. First, the incident reading reference beam L4 is diffracted by the interference fringes 71 recorded as the information in the holographic recording layer 7. Subsequently, the diffracted beam L4 is reflected by the two-state variable layer 5. Finally, a readout beam L5 is emitted from the holographic recording medium 1 in a direction of an exit angle −θ_{S}. Then, photoelectric transformation is applied on the beam L5 in order to convert its photo signals to electrical signals, so that the information recorded in the holographic recording layer 7 is two-dimensionally reproduced using image optics.

In this embodiment, the reading reference beam LA has the same wavelength as the recording signal beam L1 and the recording reference beam L2. As for beam intensity (laser power), each power of the recording signal beam L1 and the recording reference beam L2 may be larger than or equal to the power of the reading reference beam LA.

FIG. 4 shows another reading method of the holographic recording medium 1 schematically.

As shown in the figure, the reading reference beam L4 is irradiated toward the holographic recording layer 7 in a direction to make an incident angle −θ_{R} with the normal line, which is symmetrical to the above incident angle θ_{R} of the recording reference beam L2. In this case, the reading reference beam LA reflected by the two-state variable layer 5 becomes a phase conjugate beam L6. The reading reference beam L4 (the phase conjugate beam L6) is diffracted by the holographic recording layer 7, so that the reading beam L5 is emitted in a direction to make an angle θ_{S} with the normal line Ln.

If allowing the reading reference beam LA to enter the holographic recording layer 7 at an angle to produce the phase conjugate beam L6, then the reading beam L5 is emitted at the same angle θ_{S} as the incident angle of the recording signal beam L1. Therefore, it is possible to share an optical system at both recording and reading, allowing a miniaturization of a recording/reading apparatus. Additionally, even if a record-optical system, e.g. a condenser lens has an aberration, it is almost cancelled at a reading, allowing a provision of reading images with reduced distortion and noise in the reading having an improved SNR.

In the recording method of FIG. 2, if the incident angle θ_{S} of the recording signal beam L1 is equal to 0 degree, that is, the beam L1 is irradiated perpendicularly to the holographic recording layer 7, then the reading beam L1 is radiated at 0 degree of the exit angle θ_{S} with the normal line Ln (i.e. emission in a vertical direction). Thus, it becomes easy to share an optical system utilized in both recording and reading, whereby it is possible to perform recording/reading operations with high accuracy by a simple optical system.

In FIG. 2, the recording signal beam L1 and the recording reference beam L2 are irradiated to the holographic recording layer 7 at different incident angles θ_{S} and θ_{R}, respectively. However, a laser beam for the recording signal beam L1 and the recording reference beam L2 in coaxial arrangement may be irradiated to the holographic recording layer 7. Then, the incident angles θ_{S} and θ_{R} have a same angle. In irradiation, the laser beam is converged by an objective lens in a manner that the recording signal beam L1 partially interferes with a part of the recording reference beam L2 in the holographic recording layer 7. In the recording/reading operations adopting the above laser beam, the holographic recording medium 1 of this embodiment can exhibit high multiplicity in recording and an improved SNR ratio as well as the recording method of FIG. 2.

For appropriate recording/reading operations, it is required that the two-state variable layer 5 has a reflectivity less than 5% and a modulation rate more than 50% at recording.

Assume, Ra and Rc represent a reflectivity (at recording) of the two-state variable layer 5 in the amorphous state and a reflectivity (at reading) of the two-state variable layer 5 in the crystallized state, respectively. Then, a modulation rate R can be obtained by a calculation of (Rc−Ra)/Rc.

Regarding the holographic recording medium 1 of this embodiment, we examined its reflectivity Ra before the two-state variable layer 5 is crystallized (i.e. amorphous state), reflectivity Rc and modulation rate R after crystallization with parameters of respective thicknesses of the first dielectric layer 4, the two-state variable layer 5 and the second dielectric layer 6.

The holographic recording medium 1 was made as follows:
(1) Forming a reflecting layer 3 (thickness: 200 nm) while using Ag on a substrate 2 (thickness: 0.6 mm) formed by use of boron-silicate glass;
(2) Forming a first dielectric layer 4 (thickness: 7 nm) on the reflecting layer 3 by use of ZnS—SiO₂;
(3) Forming a two-state variable layer 5 (thickness: 13.5 nm) on the first dielectric layer 4 by use of Ge—Sb—Te (phase change material);
(4) Forming a second dielectric layer 6 (thickness: 50 nm) on the two-state variable layer 5 by use of ZnS—SiO₂;
(5) Forming a holographic recording layer 7 (thickness: 0.2 mm) on the second dielectric layer 6 by use of photopolymer; and
(6) Forming a transparent substrate 8 on the holographic recording layer 7, thereby forming the holographic recording medium 1.

Note, the first dielectric layer 4 and the second dielectric layer 6 are characterized by 2.1 in refractive index n and 0 in extinction coefficient k, commonly. The two-state variable layer 5 in a state of low reflectivity (amorphous state) has 3.91 in the refractive index n and 2.53 in the extinction coefficient k, while the same layer 5 in a state of high reflectivity (crystallized state) has 2.68 in the refractive index n and 5.00 in the extinction coefficient k. The reflecting layer 3 has 0.07 in the refractive index n and 4.1 in the extinction coefficient k.

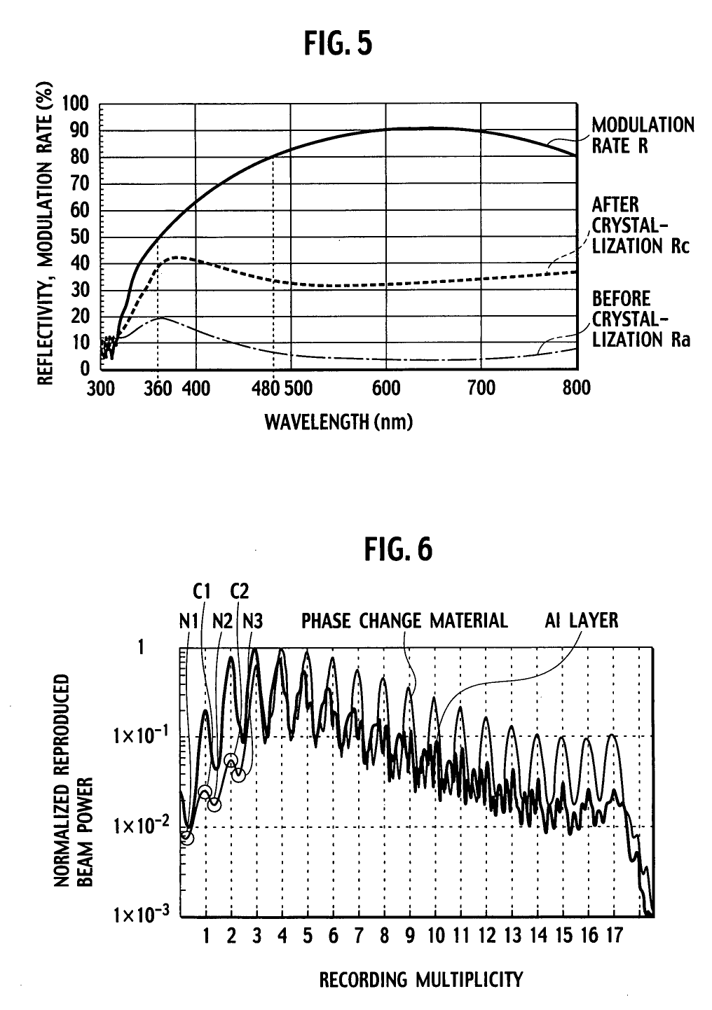

FIG. 5 is a view showing the dependency of wavelengths on the reflectivity Ra, Rc and the modulation rate R of the two-state variable layer 5. In the figure, a vertical axis denotes the reflectivity Ra, Rc and the modulation rate R, while a horizontal axis denotes wavelengths (nm) of a laser beam.

From the figure, it will be understood that if the laser beam has a wavelength larger than 360 nm, the modulation rate R (after crystallization) of the two-state variable layer 5 exceeds 50% and a difference in reflectivity between the amorphous state and the crystallized grows larger advantageously. Additionally, it is preferable that the two-state variable layer 5 has a modulation rate R (after crystallization) more than 80% for the laser beam having a wavelength within the range of 480 nm ˜800 nm and a difference in reflectivity between the amorphous state and the crystallized grows larger.

Further, we examined both reflectivity and modulation rate of the two-state variable layer 5 while changing a thickness of the first dielectric layer 4 within the range of 1 nm ˜30 nm, a thickness of the two-state variable layer 5 within the range of 1 nm ˜50 nm and a thickness of the first dielectric layer 6 within the range of 10 nm ˜200 nm. If the first dielectric layer 4 is formed with a thickness of 3 nm ˜30 nm, the two-state variable layer 5 with a thickness of 5 nm ˜40 nm and the second dielectric layer 6 is formed with a thickness of 20 nm ˜200 nm, then the reflectivity at a wavelength of 480 nm ˜800 nm exhibits a tendency similar to FIG. 5 and the modulation rate exceeds 50%, thereby producing an excellent result.

For instance, if adopting a laser beam having a wavelength of 532 nm, the modulation rate exceeding 50% is accomplished on condition of the first dielectric layer 4 with a film thickness of 3 nm ˜30 nm, the two-state variable layer 5 with a film thickness of 5 nm ˜40 nm and the second dielectric layer 6 with a film thickness of 20 nm ˜200 nm.

Next, a multiplexing was carried out to the holographic recording layer 7 in the holographic recording medium 1 produced in the above way. In the multiplexing, the incident angle θ_{S} of the recording signal beam L1 with the normal line Ln is set to 0 degree (vertical incident beam) while varying the incident angle θ_{R} of the recording reference beam L2 (parallel beam) with the normal line Ln. Subsequently, we examined respective powers of the reading beam L5 emitted from the holographic recording layer 7. The reading beam L5 is emitted in a vertical direction. The change of the two-state variable layer 5 from the amorphous state to the crystallized state was accomplished by irradiating the laser beam L3 of 500 mW˜900 mW and 810 nm in wavelength under conditions of the beam spot diameter of 2 μm˜5 μm, the laser scanning rate of 5 m/sec and the track feeding pitch of 6 μm˜20 μm.

For comparison, we made a comparative holographic recording medium under the same conditions except for the use of Al-layer in place of the two-state variable layer 5 and further examined the power of a reading beam after performing the similar recording. The comparative holographic recording medium is provided with a reflecting layer 3 of 200 nm in thickness, an Al-layer of 200 nm in thickness, no first dielectric layer 4 and no second dielectric layer 6. The recording into the holographic recording layer 7 was performed seventeen times (recording multiplicity: 17). In the embodiment, the laser beam having a wavelength of 532 nm was employed. The recording of information was carried out by irradiating a recording signal beam L1 powered with 6 mW/cm² and a recording reference beam L2 powered with 6 mW/cm² for 2 seconds.

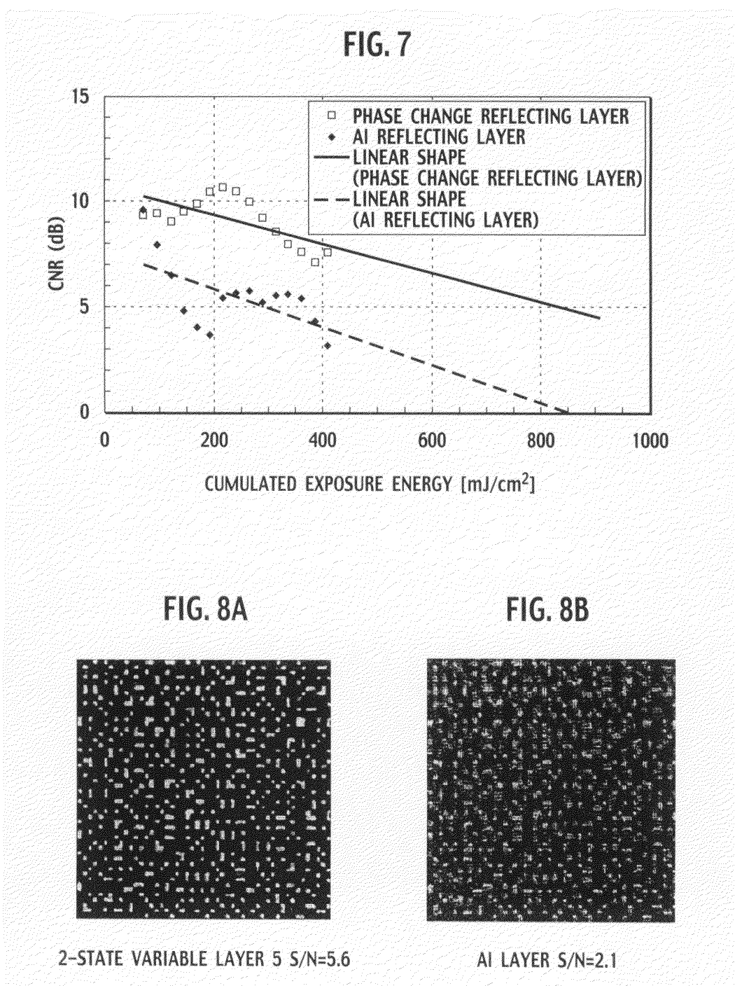

The examination results are shown in FIGS. 6 and 7.

FIG. 6 is a view showing a relationship between normalized readout beam power and recording multiplicity. In the figure, a vertical axis denotes the normalized readout beam power, while a horizontal axis denotes the recording multiplicity. In respective readout beams obtained by the holographic recording medium of this embodiment and the comparative holographic recording medium, the above normalized readout beam power designates normalized powers of readout beams on the assumption that a maximum beam power is equal to 1.

FIG. 7 is a view showing a relationship between CNR (carrier to Noise Ration: a special case of SNR that signal is carrier) and accumulated exposure energy. In the figure, a vertical axis denotes CNR, while a horizontal axis denotes the accumulated exposure energy. The parameter CNR [dB] is defined by

CNR=10 log₁₀(C/N) (1)

where “C” represents a maximum power of a readout beam (diffracted beam) in each recording multiplicity shown in FIG. 6 and “N” represents a minimum power of the readout beam equivalent to a noise level of the background. Regarding the readout beam power when adopting the two-state variable layer 5, for instance, a maximum value C at the first round in the recording multiplicity is represented by C1 in FIG. 6, while a minimum value N at the same round is represented by an average of N1 and N2 in FIG. 6 [i.e. (N1+N2)/2]. Similarly, a maximum value C at the second round in the recording multiplicity is represented by C2, while a minimum value N at the same round is represented by an average of N2 and N3. It should be noted that the information recorded in the holographic recording medium can be reproduced more advantageously as a value of CNR gets larger. In FIG. 7, “accumulated exposure energy [mJ/cm²]” means an integrated value of both the irradiation quantity of the recording signal beam L1 irradiated with respect to each recording of the holographic recording medium 1 and the irradiation quantity of the recording reference beam L2 irradiated with respect to each recording.

As shown in FIG. 6, in the holographic recording layer 7 having the two-state variable layer 5 made from the phase change material, the power of readout beam gradually decreases as the recording multiplicity increases. However, it should be noted that a readout beam having a single and sharp waveform can be provided with respect to each recording multiplicity. On the contrary, in the comparative holographic recording medium adopting Al-layer in place of the two-state variable layer 5, the waveform of a readout beam with respect to each recording multiplicity is further complicated with plural peaks as the recording multiplicity increases.

It is found that the layered structure adopting the two-state variable layer 5 can produce appropriate readout beams at a large multiplexing number, while the comparative structure adopting Al-layer in place of the two-state variable layer 5 produces readout beams with noises at a large multiplexing number.

The potential reasons for the difference between the holographic recording medium 1 and the comparative medium are as follows. That is, as the reflectivity of two-state variable layer 5 is lowered for a predetermined wavelength at the stage of recording the information into the holographic recording layer 7, the formation of unnecessary interference fringes 71 due to the re-entry of the reflected recording beams L1 and L2 into the holographic recording layer 7 is suppressed in the holographic recording medium 1, so that the beam reflected by the interference fringes 71 has little effect on the reading operation. On the contrary, the comparative medium is provided with Al-layer of a high reflectivity. Thus, the recording beams L1 and L2 are easily reflected by the Al-layer and subsequently enter the holographic recording layer 7 again, producing a large number of interference fringes 71 unnecessary at reading. In this way, the beam reflected by the interference fringes 71 has a great effect on the reading operation.

FIG. 7 shows a comparison in the integrated quantities of irradiation against respective holographic recording mediums on the assumption that a lower limit of CNR for favorable reproduction is 5 dB. From the figure, it will be understood that the holographic recording medium 1 having the two-state variable layer 5 of the phase change material is capable of recording the information repeatedly until the integrated irradiation value of the recording beams L1 and L2 reaches 800 mJ/cm². On the contrary, in the comparative medium having Al-layer in place of the two-state variable layer 5, the repetitive recording cannot be ensured under condition that the integrated irradiation value of the recording beams L1 and L2 exceeds 300 mJ/cm².

From above, it will be understood that even if the integrated irradiation value of the recording beams L1 and L2 gets more than double of an integrated irradiation value in the comparative medium adopting Al-layer, the holographic recording medium 1 adopting the two-state variable layer 5 allows the information to be reproduced favorably. Thus, it should be said that the recording multiplicity in adopting the two-state variable layer 5 is substantially doubled of the recording multiplicity in adopting Al-layer. In the holographic recording medium adopting the two-state variable layer 5, the readout beam can be produced with sufficient power. The reason is that the exposure of the holographic recording layer 7 (by reflected beams) can be held down since the reflectivity of the two-state variable layer 5 is lowered to light at recording.

By irradiating the recording signal beam L1 to the holographic recording layer 7 at the incident angle θ_{S} of 0 degree (vertical incidence) with the normal line Ln and also irradiating the recording reference beam L2 to the holographic recording layer 7 at a variable incident angle θ_{R} with the normal line Ln, we recorded the recording signals of 22.5 kbit/page on 2-4 modulation in 7-times multiplexing. Thereafter, we reproduced the information by irradiating the reading reference beam L4 at an incident angle −θ_{R} with the normal line Ln (corres. a phase conjugate reference beam of FIG. 4) and further examined a S/N ratio of the reproduced signals.

In succession, we sorted the power of signals at respective positions corresponding to respective recording bits in an image reproduced by the reading beam L5 into signal levels in 256-gradation. Further, we drafted respective histograms by further sorting each recording bit into either “0” or “1”. Assuming that μ₁ and σ₀² represent an average of the histogram “0” and its deviation, respectively, and μ₁ and σ₁² represent an average of the histogram “1” and its deviation, respectively, then the SNR of the readout beam is represented by

SNR=(μ₁−μ₀)/(σ₁²+σ₀²)^{1/2} (2)

The expression (2) implies that the further the distributions of “0” and “1” are separated from each other or the smaller their dispersions of the distributions get, the more a noise of the readout beam is lowered.

FIGS. 8A and 8B shows respective images obtained by reading the holographic recording medium 1 of this embodiment and the comparative holographic recording medium. In these figures, FIG. 8A shows one image of the holographic recording medium 1 having the two-state variable layer 5. While, FIG. 8B shows another image of the comparative holographic recording medium having Al-layer in place of the two-state variable layer 5. From the figures, it is found that the holographic recording medium 1 having the two-state variable layer 5 can provide an image where each light part corresponding to “1” and each dark part corresponding to “0” are clarified with lowered noise, in comparison with the comparative holographic recording medium. In addition, the SNR of the image by the holographic recording medium 1 is preferable.

According to this embodiment, it is established that the incident angle θ_{S} of the recording reference beam L1 with the normal line Ln becomes equal to 0 degree (vertical incidence). Thus, since the incident angle of the recording signal beam L1 coincides with the exit angle of the readout beam L5, the recording/readout of information can be accomplished with a simplified optical system. Furthermore, owing to the adoption of a phase conjugate beam at reading, it is possible to provide a readout image with a reduced image distortion.

Even if adopting inorganic materials or organic dye materials for the two-state variable layer 5, preferable recording/readout operations could be accomplished similarly to the case of the holographic recording medium 1 having the two-state variable layer 5.

In the holographic recording medium 1 of this embodiment, since the reflectivity of the two-state variable layer 5 against the light having a predetermined wavelength is lowered at recording the information in the holographic recording layer 7, it is possible to prevent a formation of unnecessary diffraction grating due to the formation of unnecessary interference fringes 71 by lights reflected by the two-state variable layer 5 and entering the holographic recording layer 7 again, whereby the recording multiplicity can be increased. Further, since the holographic recording medium 1 of this embodiment can produce the interference fringes 71 as the information derived from only interference between the recording signal beam L1 and the recording reference beam L2 both entering the holographic recording layer 7, allowing a performance of favorable recording.

Again, as the above-mentioned interference fringes 71 are recorded in the holographic recording layer 7, it is possible to attain a favorable SNR at reading the holographic recording layer 7 with the reading reference beam L4.

### 2^{nd}. Embodiment

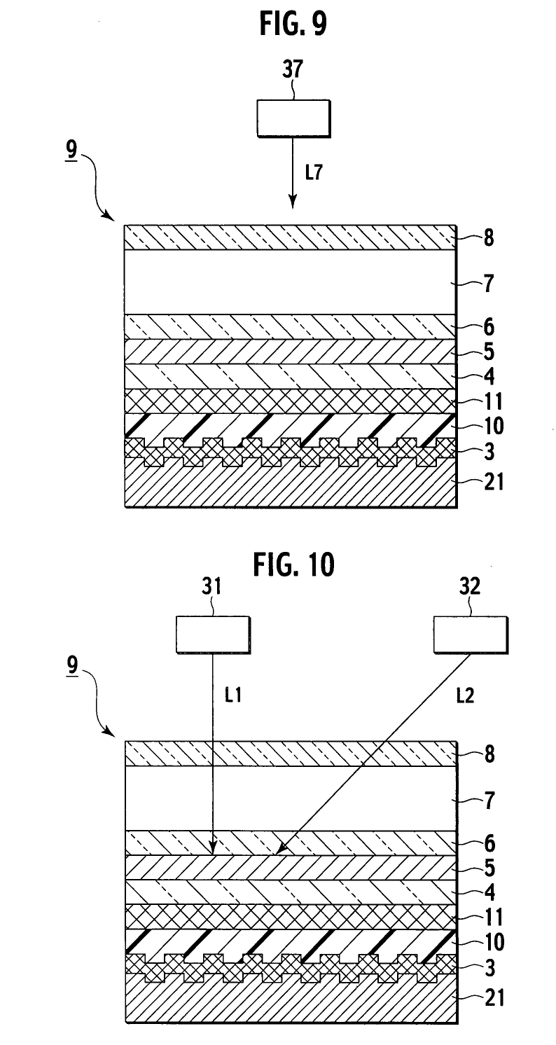

A holographic recording medium 9 in accordance with the second embodiment of the present invention will be described with reference to FIG. 9.

In this embodiment, the holographic recording medium 9 is provided with a disc-shaped substrate 21. The holographic recording medium 9 contains format signals for controlling recording or reading of information, which are recorded in the form of irregularities. The format signals comprise tracking signals, address signals, recording/reading control signals and so on. The holographic recording medium 9 differs from the above-mentioned holographic recording medium 1 of the first embodiment in that a smoothing layer 10 and a reflecting layer 11 are interposed between the reflecting layer 3 and the first dielectric layer 4, in sequence from one side of the layer 3. The other constitution is identical to that of the first embodiment.

A servo beam L7 for reading the format signals is generated by a servo-beam generator 37. The servo beam L7 is irradiated to the holographic recording medium 9 from one side facing the transparent substrate 8. Similarly to the holographic recording medium 1 mentioned before, other beams for recording and reading the information are also irradiated from the medium's side facing the transparent substrate 8.

For the smoothing layer 10, there is available a material having fluidity in its early stage, curing by heat, light or oxidization, and optical characteristics allowing a transmission of the servo beam L7, for example, epoxy resin.

The reflecting layer 11 is formed by material that is characterized by allowing a transmission of the servo beam L7 and reflecting the recording signal beam L1, the recording reference beam L2 and the reading reference beam LA all transmitted through the holographic recording layer 7. For the reflecting layer 11, there are available, for instance, amorphous carbon, DLC (diamond-like carbon), these carbon materials containing either H or N, Si, SiHₓ, SiNₓ and so on.

In the modification, the reflecting layer 11 may be formed by a dichroic mirror layer.

Then, the dichroic mirror layer comprises a lamination of one layer of high refractive-index material (e.g. Nb₂O₅, Ta₂O₅, ZnS—SiO₂, Si₃N₄, TiO₂) and another layer of low refractive-index material (e.g. MgF₂, SiO₂).

Note that the reflecting layer 11 having a “dichroic mirror” function would offer an advantage in the possibility of separating the servo beam L7 and the recording/reading beams for the holographic recording layer 7 from each other.

Owing to the interposition of the smoothing layer 10 and the reflecting layer 11 between the reflecting layer 3 and the first dielectric layer 4, it becomes easy to read out the format signals. The lamination of the holographic recording medium 9 is convenient for a medium in the form of a disc.

The recording/reading methods of the holographic recording medium 9 are similar to those of the holographic recording medium 1 in the first embodiment and therefore, their explanations are eliminated.

According to the second embodiment, the holographic recording medium 9 is capable of accomplishing appropriate recording and reading as well as the holographic recording medium 1 of the first embodiment.

### 3^{rd}. Embodiment

In common with the first and second embodiments mentioned above, there is provided, between the information recording step (i.e. formation of the interference fringes 71 in the holographic recording layer 7) and the information reading step (i.e. reproducing information from the layer 7), a reflectivity setting process for changing the two-state variable layer 5 from its low-reflectivity state to the high-reflectivity state. In the reflectivity setting process, the setting beam L3 for bringing the two-state variable layer 5 into the high-reflectivity state is irradiated to establish a reflectivity of the layer 5. In the previous embodiments, the phase change material is employed as the two-state variable layer 5. In the reflectivity setting process, it is executed to change the layer 5 from the amorphous state to the crystallized state.

On the contrary, according to the third embodiment, the recording signal beam L1 or the recording reference beam L2 is irradiated so as to reach the two-state variable layer 5 as shown in FIG. 10, performing the reflectivity setting process at the same time of forming the interference fringes 71 in the holographic recording layer 7. In detail, by focusing the recording signal beam L1 or the recording reference beam L2 to the two-state variable layer 5, it is heated up so that its temperature becomes more than a temperature allowing the layer 5 to change to the high-reflectivity state, at the same time of recording the information in the holographic recording layer 7.

In various materials suitable for the two-state variable layer 5, a phase change material containing chalcogen element is crystallized in a cooling process after heating up the layer 5. Thus, if adopting the phase change material containing chalcogen element, the recording into the holographic recording layer 7 is completed in advance of the crystallization of the two-state variable layer 5. Therefore, there is no possibility that the reflectivity has changed in the middle of recording the information, improving the quality of recording operation.

In connection, if adopting a light-sensitive (photon-mode) material for the holographic recording layer 7, then the holographic recording can be completed before the two-state variable layer 5 changes since the photon-mode material has a reaction rate higher than that of a temperature-sensitive (heat-mode) material provided for the two-state variable layer 5. Thus, it is possible to accomplish the holographic recording under condition of less effect by the reflecting beam advantageously.

Consequently, it is possible to eliminate the above setting process of bringing the two-state variable layer 5 into the high-reflectively state for the reading reference beam L4 in advance of the reading operation. Thus, as there is no need of providing the beam generator 33 for the setting beam L3, the recording/reading apparatuses can be simplified.

Alternatively, if forming the holographic recording layer 7 by photo polymer material, it is necessary to make the holographic recording layer 7 fixed and exposed all over the layer's area in order to complete the polymerization of monomer after recording. Under such a situation, if forming the two-state variable layer 5 by the phase change material, there arises the need of providing the above-mentioned reflectivity setting process. Therefore, if allowing a wavelength of a light used in the reflectivity setting process to accord with a wavelength of the light for exposing the monomer in the holographic recording layer 7, then it is possible to perform the process of changing the two-state variable layer 5 to the crystallized state at the same time of photo polymerization, whereby the recording/reading apparatuses can be simplified.

In conclusion, according to the present invention, it is possible to increase the number of multiplexing and also possible to accomplish the reading operation for the holographic recording medium with an improved SNR.

Finally, it will be understood by those skilled in the art that the foregoing descriptions are nothing but embodiments of the disclosed holographic recording medium, the recording/reading methods and the recording/reading apparatuses for the holographic recording medium and therefore, various changes and modifications may be made within the scope of claims.

1. A holographic recording medium comprising:
a holographic recording layer for recording information holographically by incident recording beams; and
a two-state variable layer arranged on one side of the holographic recording layer in a thickness direction thereof, the one side of the holographic recording layer being opposite to an incident side of the holographic recording layer; wherein
the two-state variable layer is made from a material whose state can be changed between a first state and a second state by receiving a light and whose reflectivity can be changed between a first reflectivity corresponding to the first state and a second reflectivity corresponding to the second state, and
the second reflectivity is higher than the first reflectivity.

2. The holographic recording medium of claim 1, further comprising a dielectric layer arranged between the holographic recording layer and the two-state variable layer.

3. The holographic recording medium of claim 2, further comprising a substrate in which format signals for controlling a recording of the information into the holographic recording medium or a readout of the information from the holographic recording medium are recorded, wherein
the substrate is arranged on one side of the two-state variable layer in a thickness direction thereof, the one side of the two-state variable layer being opposite to the incident side of the holographic recording layer.

4. The holographic recording medium of claim 1, wherein the two-state variable layer is made from any one of a phase change material, an inorganic material and an organic dye material.

5. A recording method of recording information into a holographic recording medium, wherein:
the holographic recording medium comprises:
a holographic recording layer for recording the information holographically by incident recording beams; and
a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and
the recording method comprises:
a reflectivity setting step of setting that the two-state variable layer has the first reflectivity corresponding to the first state; and
a recording step of recording the information into the holographic recording layer by the incident recording beam.

6. The recording method of claim 5, wherein:
the incident recording beams used as the recording step comprise a first beam containing the information and a second beam for recording the information into the holographic recording layer together with the first beam.

7. The recording method of claim 6, wherein:
the recording step comprises:
a step of allowing the first beam to enter the holographic recording medium at a first angle with a normal line perpendicular to an incident plane of the holographic recording medium for the incident recording beam; and
a step of allowing the second beam to enter the holographic recording medium at a second angle with respect to the normal line.

8. The recording method of claim 7, wherein the first angle is equal to 0 degree.

9. The recording method of claim 5, wherein at the reflectivity setting step, a setting beam for setting the reflectivity of the two-state variable layer to the first reflectivity correspond to the first state used.

10. A reading method of reading information from a holographic recording medium, wherein:
the holographic medium comprises:
a holographic recording layer for recording the information holographically by incident recording beams; and
a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and
the reading method comprises:
a reflectivity setting step of setting the reflectivity of the two-state variable layer to the second reflectivity corresponding to the second state; and
a reading step of reading the information from the holographic recording layer by a reading beam.

11. The reading method of claim 10, wherein at the reflectivity setting step, a setting beam for changing the reflectivity of the two-state variable layer from the first reflectivity corresponding to the first state to the second reflectivity corresponding to the second state is used.

12. The reading method of claim 10, wherein at the reflectivity setting step, either a first beam having the information or a second beam for recording the information into the holographic recording layer together with the first beam is used.

13. A recording apparatus for recording information in a holographic recording medium wherein:
the holographic recording medium comprises:
a holographic recording layer for recording the information holographically by incident recording beams; and
a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and
the recording apparatus comprising:
a first beam generator for generating a first beam having the information, the first beam constituting a part of the recording beam;
a second beam generator for generating a second beam for recording the information in the holographic recording layer together with the first beam, the second beam constituting another part of the recording beam; and
a third beam generator for generating a third beam for setting the reflectivity of the two-state variable layer to the first reflectivity corresponding to the first state.

14. A reading apparatus for reading information from a holographic recording medium wherein:
the holographic recording medium comprises:
a holographic recording layer for recording the information holographically by incident recording beams; and
a two-state variable layer arranged on one side of the holographic recording layer in a thickness direction thereof, the one side of the holographic recording layer being opposite to an incident side of the holographic recording layer, wherein the two-state variable layer is made from a material whose state can be changed between a first state and a second state by receiving a light and whose reflectivity can be changed between a first reflectivity corresponding to the first state and a second reflectivity corresponding to the second state, and the second reflectivity is higher than the first reflectivity; and
the reading apparatus comprises:
a first beam generator for generating a setting beam for setting the reflectivity of the two-state variable layer to the second reflectivity corresponding to the second state; and
a second beam generator for generating a reading beam for reading the information recorded in the holographic recording layer.

15. The holographic recording medium of claim 2, wherein the two-state variable layer is made from any one of a phase change material, an inorganic material and an organic dye material.

16. The holographic recording medium of claim 3, wherein the two-state variable layer is made from any one of a phase change material, an inorganic material and an organic dye material.

17. The recording method of claim 6, wherein at the reflectivity setting step, a setting beam for setting the reflectivity of the two-state variable layer to the first reflectivity correspond to the first state used.

18. The recording method of claim 7, wherein at the reflectivity setting step, a setting beam for setting the reflectivity of the two-state variable layer to the first reflectivity correspond to the first state used.

19. The recording method of claim 8, wherein at the reflectivity setting step, a setting beam for setting the reflectivity of the two-state variable layer to the first reflectivity correspond to the first state used.
